(19) United States
(12) Patent Application Publication
(10) Pub. No.: US 2010/0005154 A1
(43) Pub. Date: Jan. 7, 2010

(54) METHOD AND APPARATUS FOR OBTAINING INFORMATION FOR TRANSFER OF AN EXTERNAL CONTENT

(75) Inventors: Yu Kyoung Song, Gyeonggi-do (KR); Kyung Ju Lee, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC., SEOUL (KR)

(21) Appl. No.: 12/160,768

(22) PCT Filed: Jan. 12, 2007
(86) PCT No.: PCT/KR07/00216

§ 371 Date: Sep. 11, 2009

Related U.S. Application Data
(60) Provisional application No. 60/759,245, filed on Jan. 13, 2006.
(60) Provisional application No. 60/764,706, filed on Feb. 1, 2006.

(51) Int. Cl. G06F 15/16; G06F 15/173

(52) U.S. Cl. 709/219; 709/223; 709/228

(57) ABSTRACT

The present invention is to notify a user of whether content streaming service will be provided well or not by obtaining information for transfer of a content to be provided from outside before traffic of the content starts to be transferred. In a method according to the present invention, a CP (Control Point) or a gateway at a home network obtains requests an external server to provide information for transfer of a content stored in the external server, a TD (Traffic Descriptor) is constructed based on the provided information for transfer, and a QoS (Quality of Service) manager invokes an action requesting permission of traffic requiring a bandwidth specified by the TD to devices to be involved in traffic transferring of the content.

### TECHNICAL FIELD

The present invention relates to technology for obtaining information about an external content over a home network such as UPnP-based home network.

### BACKGROUND ART

Networking technologies based on various types of small-sized devices have been emerged and commercialized recently A home network enables to interconnect various consumer electronics devices such as refrigerator, TV set, washing machine, PC, and stereo set, making it possible to provide a convenient, user-friendly living environment. The UPnP™ (hereinafter, referred to UPnP) standard has been proposed to offer such a digital home network platform.

An UPnP network usually comprises a plurality of UPnP devices, services and a control point (CP). Each service, the smallest accessible and controllable unit in an UPnP network is modeled by its own unique state variables. In general, the CP is a control application running on a device in the network such as PDA and is capable of accessing, monitoring, and controlling all of the devices on the network and/or their services. The CP can also be implemented on a device, together with media renderer service that enables to display media data such as video data. It is possible that a plurality of CPs exist in a UPnP network and therefore a user can choose a nearer or more accessible CP so that he/she makes requests for desired services and for controlling the services at his/her convenience.

Specifically, the UPnP home network enables us at anyplace to execute desired operations such as move or copy of data between different devices connected to the home network at the chosen CP conveniently and to share the various devices at the same time.

Therefore it possibly happens that when a plurality of users use the devices in the network at the same time or sequentially or when a plurality of tasks are executed on the devices at the same time or sequentially, the bandwidth in the network required for doing the jobs exceeds the network bandwidth available at that time. If this case happens, new access requests for data transfer must be rejected. Accordingly, a home network needs a QoS (Quality of Service) manager being capable of managing network access that will use network resources.

However, in the event that a user wants to view a content stored in an external server in streaming manner through a certain device among devices on the home network and an access network to which the home network is connected to, there is no way to know transfer information, e.g., traffic speed of streaming demanded by the external content. Therefore, after the streaming service is started it possibly happens that the streaming service can not provided well and smoothly under transfer resource of the home network.

For example, in the event that a user is viewing through a device, e.g., media renderer a content of HD (High Definition) quality on a media server of a home network using transfer resource of the home network, another content, e.g., a VOD (Video On Demand) movie title (capable of being streamed in both SD and HD quality) stored on an external server may start to come in the home network in the transfer speed equivalent to HD quality when another user requests streaming of the VOD movie title in HD quality mode through another device. However, if the current transfer resource of the home network is not able to support the required transfer speed because of streaming service of other contents, the another user undergoes intermittent video breaks and/or delays in viewing the external VOD movie title, which will raise user's dissatisfaction. Moreover, because it is common that the external high-quality contents are provided with fee, a user may pay even for such unsatisfactory streaming service.

### DISCLOSURE OF THE INVENTION

At least one object of the present invention is to obtain information needed for inward transfer of an external content thereby knowing whether traffic transfer service is conducted with no problem before the service starts.

A method for accessing content on a server at outside of a local network according to the present invention, comprises requesting the server to send information for transfer of the content, preparing a TD (Traffic Descriptor) based on the information for transfer provided in response to the request, and issuing an action for requesting allowance of a traffic demanded by the prepared TD to devices to be involved in transferring traffic of the content.

In one embodiment according to the present invention, if any response to the invoked action for requesting allowance of a traffic contains ‘Refusal’, it is notified a user that acceptance of the content into the local network is impossible.

In one embodiment according to the present invention, a control application, which inquires and/or controls states of devices on the local network, requests the server to send the information for transfer of the content and receives the information for transfer.

In another embodiment according to the present invention, if a content on the server is selected, a gateway device of the local network for an external network is regarded as a virtual source device in transferring of the selected content.

In the another embodiment, the gateway device requests the server to send information for transfer of the selected content and receives the information for transfer.

In the another embodiment, the gateway device prepares a TD of the selected content and provides the prepared TD for a QoS manager for managing traffics on the local network.

### BRIEF DESCRIPTION OF THE DRAWINGS

FIG. 1 illustrates signal flows among devices conducted prior to streaming of a content stored inside a home network;

FIG. 2 illustrates signal flows among devices conducted prior to streaming of a content stored outside a home network in accordance with an embodiment of the present invention; and

FIG. 3 illustrates signal flows among devices conducted prior to streaming of a content stored outside a home network in accordance with another embodiment of the present invention.

### BEST MODE FOR CARRYING OUT THE INVENTION

Hereinafter, embodiments according to the present invention will be described in detail with reference to appended drawings.

In one embodiment according to the present invention, in case of a content stored in a device, e.g., a media server connected to a home network, information for transfer (hereinafter, abbreviated to ‘IFT’) of traffic to be provided at a request of access allowance for transfer of the content is partially written in meta data of the content. Therefore, a control point prepares a TD based on the written information in meta data and delivers the prepared TD to a QoS manager. The TD includes information on type of traffic, e.g., realtime (streaming data) or non-realtime, information indicative of changeability in service quality, and information specifying requirement (also called “Tspec information”) for each of service qualities of a content, e.g., HD and SD. The Tspec information includes information on service rate (transfer speed) demanded for streaming of traffic of corresponding service quality. The terms of ‘Tspec’ and ‘QoS’ are not mandatory ones in this invention, that other terms may be chosen instead.

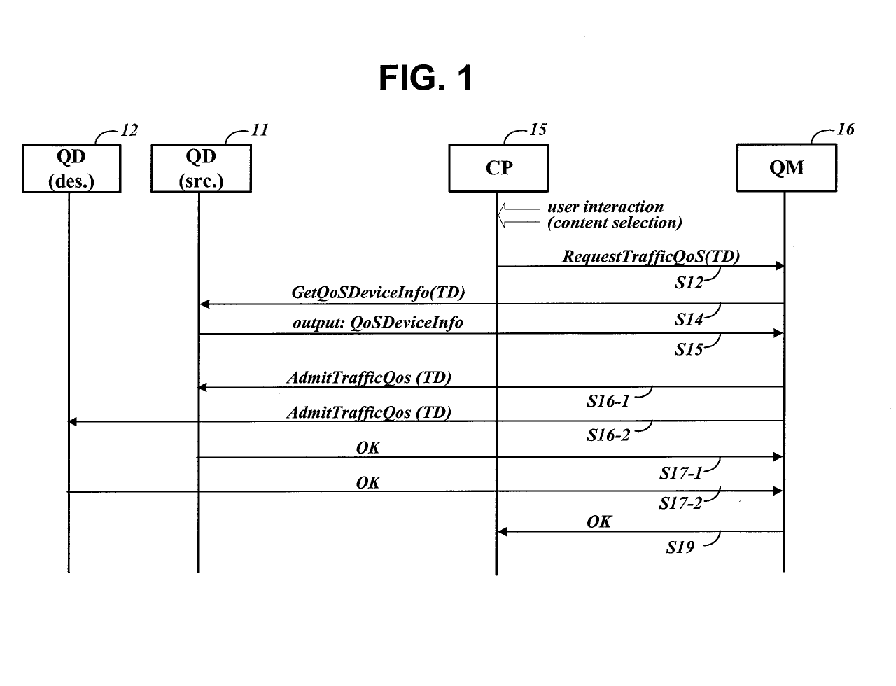

For fields (elements) of the TD not obtained by the CP from meta data of a content chosen by a user, the QoS manager requests a device, which will conduct transfer of the content, to send information needed to fill in those fields. FIG. 1 shows illustrative signal flows for such a case.

As mentioned above, if a user selects a content from browsed contents, a control point (CP) 15 makes out a TD from information of meta data of the selected content. The TD made out at this time includes Tspec information specifying transfer speed needed for service quality of the selected content. The CP 15 issues an action RequestTrafficQoS( ) for requesting connection setup for transfer of the content traffic while providing the made-out TD for a QoS manager 16 (S12). At this time, the CP 15 leaves fields, whose information is not obtained from the meta data, of the TD blank. The QoS manager 16 examines information, which is carried by the connection-setup requesting action, on resources and devices to be involved in transferring the content, and issues an action GetQoSDeviceInfo( ) carrying the received TD for inquiring device information to a source QoS device 11 that is identified as a source of the content transfer from the examination (S14).

The QoS device 11 received the action GetQoSDeviceInfo( ) identifies traffic to be serviced based on the TD carried by an input argument of the received action, fills an argument “QoSDeviceInfo” with information on resource and format (e.g., SourcePort, DestinationPort, Protocol, PathMTU, MaximumPacketSize, NominalPacketSize, etc.) needed for transfer of the identified traffic, and provides the argument “QoSDeviceInfo” as response to the action GetQoSDeviceInfo( ) (S15). The QoS manager 16 fills a part or all of blanks of the TD using the information included in the received argument “QoSDeviceInfo”, and invokes an action for requesting traffic allowance demanded by the TD respectively to source and destination devices 11 and 12 to be involved in transferring the traffic while providing the TD as input argument of the traffic allowance requesting action (S16-1,S16-2). FIG. 1 shows only source and destination devices for simplifying drawings, however, if there is any device which the traffic is transferred via, the traffic allowance requesting action is also invoked to such pass-through device.

For the invoked traffic allowance requesting action, each of the QoS devices 11 and 12 examines whether its remaining transfer resource is able to support demand of the received TD, and it makes response of ‘Allowance’ (OK) if supportable (S17-1,S17-2). If all the responses are OK the QoS manager 16 also sends OK (S19) in response to the previously-invoked action RequestTrafficQos( ), otherwise it responds ‘Refusal’ (FAIL).

If OK is received in response to the action RequestTrafficQos ( ), the CP 15 invokes actions needed for streaming of the selected content to involved AV devices (e.g., media server and media renderer which are respectively corresponding to the QoS devices 11 and 12) so that the content selected by a user starts to be played.

Hereinafter explained is an embodiment according to the present invention for obtaining IFT of an external content in the event that a content on a server located at outside of a home network is requested to be streamed inward.

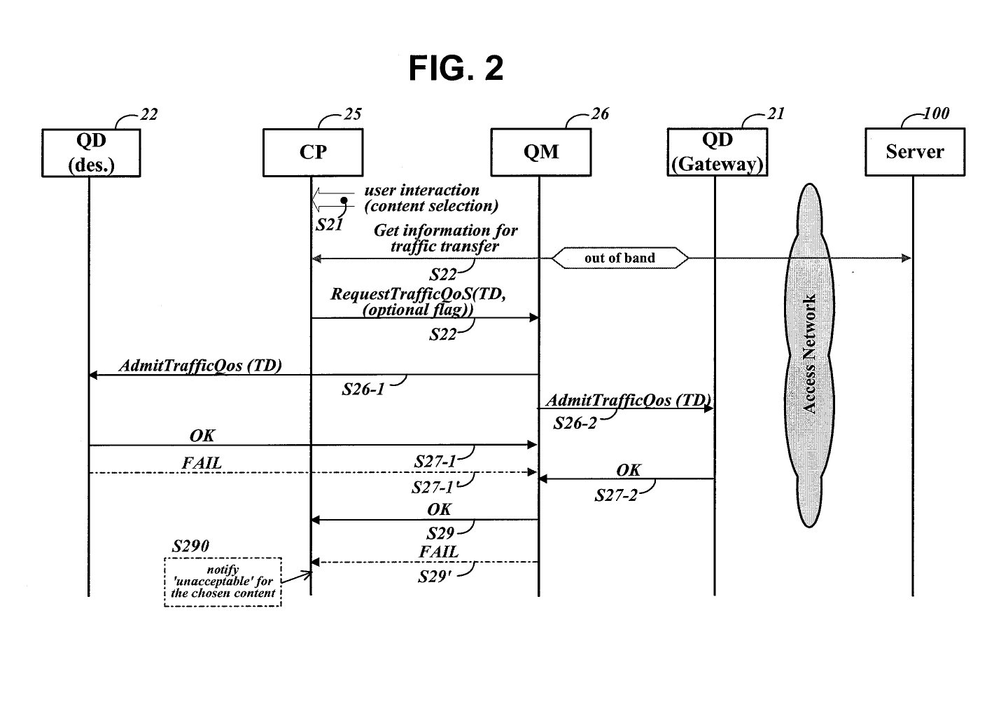

FIG. 2 illustrates signal flows among devices for the above-mentioned case in accordance with an embodiment of the present invention. In the present embodiment, a list of contents obtained from browsing an external server 100 does not contain IFT, e.g., information on demanding transfer bandwidth, etc. for each content. Therefore, when a user selects a content on the list for streaming through a CP 25 (S21) the CP 25 identifies source information, e.g., URL of the selected content and requests the designated external server 100 to send IFT of the content (S22) if the identified URL indicates location not on an internal home network but on an external network. At the requesting, not protocol adopted by the home network but protocol admitted by the external network is used. One of well-known protocols may be used for the inter-network communication. If necessary, the CP 25 executes a particular application supporting protocol for communicating information with the external server 100 in order to obtain IFT of a content from the external server 100. The executed particular application obtains necessary ITF from the external server 100 and returns it to the CP 25. The obtained IFT includes information on bandwidth demanded by the content or a designated service quality of the content.

The CP 25 prepares a TD from the obtained ITF and invokes, to a QoS manager 26, an action carrying the prepared TD to request a connection setup (S22). At this time, an optional flag may be also delivered to the QoS manager 26 to notify that the connection setup is for a content located not inside a home network but outside.

In the event that the optional flag is provided, the QoS manager 26 knows from the optional flag a fact that the request of a connection setup is for a content located outside the home network. In case of no optional flag, the QoS manager 26 knows the fact from source information (i.e., the external server 100) of the content. If the fact is recognized, the QoS manager 26 does not invoke the action for inquiring device information (Differently, this action is invoked in the previous embodiment.) although the received TD includes blank fields. Instead, the QoS manager 26 invokes an action for requesting traffic allowance demanded by the received TD respectively to source and destination devices (a destination device 22 and a pass-through device 21, i.e., gateway device) to be involved in transferring the traffic while providing the received TD as input argument of the traffic allowance requesting action (S26-1,S26-2).

For the invoked traffic allowance requesting action, each of the QoS devices 21 and 22 examines whether its remaining transfer resource is able to support demand of the received TD, and it makes response of ‘Allowance’ (OK) if supportable (S27-1,S27-2). If all the responses are OK the QoS manager 26 also sends OK (S29) in response to the previously-invoked action for requesting a connection setup, otherwise it responds ‘Refusal’ (FAIL).

If OK is received in response to the connection setup requesting action, the CP 25 invokes actions needed for streaming of the selected content to an involved AV device (e.g., media renderer corresponding to the destination QoS devices 22) and also sends a message of matched protocol for requesting the external server 100 to start streaming of the content, so that the content selected by a user starts to be played through transfer between networks.

In the meantime, if any device (e.g., the destination QoS device 22 in FIG. 2) among devices on path of the transfer over the home network is not able to support the bandwidth demanded by the received TD, it responds FAIL (S27-1′). As such a case, if a refusal response is received from any QoS device, the QoS manager 26 responds FAIL to the previously-received connection setup requesting action (S29′). According to the FAIL response, the CP 25 provides a user, in a proper displaying manner, with a notifying message that the selected content or the chosen service quality of the content is not acceptable under present remaining transfer resource of the home network (S290).

Recognizing the notification, the user becomes aware that the selected content or service quality thereof is not supportable by the home network although it is supportable by the external access network, and does not request streaming of the content that will charge to the user in case that the selected content or service is not for free. Therefore, the present invention basically prevents waste of money that would be caused from user's request of poor service expected content streaming because of non-provision of the aforementioned notification.

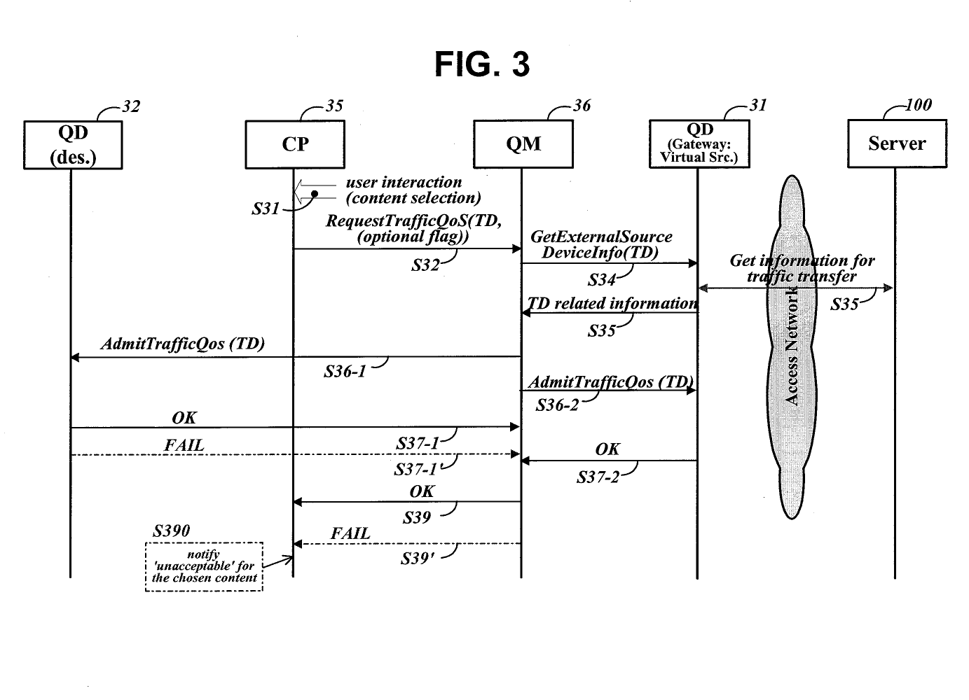

Hereinafter explained is another embodiment according to the present invention for obtaining IFT of an external content in the event that a content on a server located at outside of a home network is requested to be streamed inward. The present embodiment is described with reference to the illustrated signal flows of FIG. 3.

In the present embodiment, a list of contents obtained from browsing an external server 100 does not contain IFT, e.g., information on demanding transfer bandwidth, etc. for each content the same as in the previous embodiment explained with reference to FIG. 2. Therefore, when a user selects an external content for streaming through a CP 35 (S31) the CP 35 prepares a TD from meta data of the selected content and invokes an action RequestTrafficQos ( ) for requesting a connection setup for transfer of content traffic to QoS manager 36 while providing the prepared TD (S32). At this time, most fields of the prepared TD are left blank because the selected content is a browsed one from the external server 100 and related IFT can not be obtained from the meta data.

In the meantime, the CP 35 may identify source information, e.g., URL of the selected content and delivers an optional flag for the QoS manager 36 if the identified URL indicates location not on an internal home network but on an external network. The optional flag is used to notify that the connection setup is for a content located not inside a home network but outside.

In the event that the optional flag is provided, the QoS manager 36 knows from the optional flag a fact that the request of a connection setup is for a content located outside the home network. In case of no optional flag, the QoS manager 36 knows the fact from source information (i.e., the external server 100) of the content. If the fact is recognized, the QoS manager 36 issues an action GetExternalSourceDeviceInfo( ) for inquiring device information of an external source to a QoS device 31 of virtual source (In common, a device functioning as a gateway of the home network is designated as a virtual source) while providing the received TD (S34).

The QoS device 31 of virtual source received the action GetExternalSourceDeviceInfo( ) identifies traffic to be serviced based on the TD carried by an input argument of the received action, and requests the external server 100 identified as a source of the selected content to send information, namely a part of ITF related to the selected content. Receiving the information from the external server 100, the QoS device of virtual source fills the blank fields (transfer speed of traffic, etc.) of the TD with the received information (S35).

In the meantime, when requesting for the IFT-related information, not protocol adopted by the home network but protocol admitted by the external network is used. One of well-known protocols may be used for the inter-network communication. In addition, if necessary, the QoS device 31 of virtual source executes a particular application supporting protocol for communicating information with the external server 100 in order to obtain IFT-related information from the external server 100. The executed particular application obtains necessary ITF-related information from the external server 100 and returns it to the caller of the QoS device 31. The obtained IFT-related information includes information on bandwidth demanded by the content or a designated service quality of the content.

The QoS device 31 of virtual source, in response to the received action GetExternalSourceDeviceInfo( ), sends the QoS manager 36 the obtained IFT-related information and information on resource and format, namely TD-related information needed for transfer of the identified traffic (S35).

Receiving all information needed for transfer of the selected content, the QoS manager 36 completes the TD using the received information and invokes an action for requesting traffic allowance demanded by the TD respectively to source (virtual source) and destination devices 31 and 32 to be involved in transferring the traffic while providing the completed TD as input argument of the traffic allowance requesting action (S36-1,S36-2). At this time, if there is any device which the traffic is transferred via, the traffic allowance requesting action is also invoked to such pass-through device.

For the invoked traffic allowance requesting action, each of the QoS devices 31 and 32 examines whether its remaining transfer resource is able to support demand of the received TD, and it makes response of ‘Allowance’ (OK) if supportable (S37-1,S37-2). If all the responses are OK the QoS manager 36 also sends OK (S39) in response to the previously-invoked action for requesting a connection setup, otherwise it responds ‘Refusal’ (FAIL).

If OK is received in response to the connection setup requesting action, the CP 35 invokes actions needed for streaming of the content to an involved AV device (e.g., media renderer corresponding to the destination QoS devices 32) and also sends a message of matched protocol for requesting the external server 100 to start streaming of the content, so that the content selected by a user starts to be played through transfer between networks.

In the meantime, if any device (e.g., the destination QoS device 32 in FIG. 3) among devices on path of the transfer over the home network is not able to support the bandwidth demanded by the received TD, it responds FAIL (S37-1′). As such a case, if a refusal response is received from any QoS device, the QoS manager 36 responds FAIL to the previously-received connection setup requesting action (S39′). According to the FAIL response, the CP 35 provides a user, in a proper displaying manner, with a notifying message that the selected content or the chosen service quality of the content is not acceptable under present remaining transfer resource of the home network (S390).

From the same reason explained in the embodiment of FIG. 2, the notification according to the present embodiment basically prevents user's waste of money that would be caused from user's request of poor service expected content streaming because of non-provision of the aforementioned notification.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for accessing content on a server at outside of a local network, comprising:
requesting the server to send information for transfer of the content and preparing a traffic descriptor based on the information for transfer provided in response to the request; and
issuing an action for requesting allowance of a traffic demanded by the prepared traffic descriptor to devices to be involved in transferring traffic of the content.

2. The method of claim 1, further comprising a step of notifying a user that transfer of the content into the local network is not acceptable, if a response to the issued action is indicative of non-permission.

3. The method of claim 1, wherein the information for transfer of the content includes information on transfer speed demanded by traffic of the content.

4. The method of claim 1, wherein a control application that inquires and/or controls states of devices on the local network requests the server to send the information for transfer of the content.

5. The method of claim 1, wherein a gateway device that functions as a gateway of the local network for an external network requests the server to send the information for transfer of the content.

6. An apparatus for constituting a local network, comprising:
a control application for inquiring and/or controlling states of devices on the local network; and
a managing processor for managing traffics transferred through the local network,
wherein the control application, if a content stored in an external server located at outside of the local network is selected, requests the external server to send information for transfer of the selected content, prepares a traffic descriptor based on the information for transfer provided from the external server, and issues to the managing processor an action for requesting a connection setup over the local network for transferring the selected content while providing the prepared traffic descriptor for the managing processor.

7. The apparatus of claim 6, wherein if the action for requesting a connection setup is received, the managing processor issues an action for requesting allowance of a traffic demanded by the traffic descriptor carried by the connection setup requesting action to all of devices on the local network to be involved in transferring the selected content.

8. The apparatus of claim 7, wherein if non-permission is received from any of the involved devices in response to the allowance requesting action, the managing processor sends the control application a response of the connection setup requesting action that indicates not-permitted.

9. The apparatus of claim 8, wherein if non-permission is received as a response of the connection setup requesting action, the control application notifies a user that transfer of the content into the local network is not acceptable.

10. An apparatus for constituting a local network, comprising:
a managing processor for managing traffics transferred through the local network;
a gateway device for functioning as a gateway of the local network for an external network; and
a control application for inquiring and/or controlling states of devices on the local network and issuing to the managing processor an action for requesting a connection setup over the local network for transferring a selected content,
wherein the managing processor, if the selected content is stored in an external server located at outside of the local network, requests the gateway device to send information used for preparing a traffic descriptor of the selected content and receives the information from the gateway device.

11. The apparatus of claim 10, wherein the gateway device requests the external server to send information needed for completing the traffic descriptor and receives the information from the external server.

12. The apparatus of claim 10, wherein if the information is received, the managing processor completes the traffic descriptor based on the received information and issues an action for requesting allowance of a traffic, whose speed is demanded by the completed traffic descriptor, to devices on the local network to be involved in transferring traffic of the selected content.

13. The apparatus of claim 12, wherein if non-permission is received from any of the involved devices in response to the allowance requesting action, the managing processor sends the control application a response of the connection setup requesting action that indicates not-permitted.

14. The apparatus of claim 13, wherein if non-permission is received as a response of the connection setup requesting action, the control application notifies a user that transfer of the content into the local network is not acceptable.

15. The apparatus of claim 10, wherein an action issued by the managing processor to request the gateway device to send information used for preparing a traffic descriptor of the selected content is different from a device information inquiring action “GetQoSDeviceInfo( )” which is issued to a source device in case that a content located at inside of the local network is selected.
